(19) United States
(12) Patent Application Publication
(10) Pub. No.: US 2011/0287978 A1
(43) Pub. Date: Nov. 24, 2011

(54) CELL CHIP

(75) Inventors: Dong Woo LEE, Gyunggi-do (KR); Se Hoon JEONG, Seoul (KR); Sang Jin KIM, Gyunggi-do (KR); Jeong Suong YANG, Gyunggi-do (KR); Bo Sung KU, Gyunggi-do (KR)

(73) Assignee: SAMSUNG ELECTRO-MECHANICS CO., LTD., Gyunggi-do (KR)

(21) Appl. No.: 12/881,899

(22) Filed: Sep. 14, 2010

(30) Foreign Application Priority Data
May 24, 2010 (KR) 10-2010-0048226

(51) Int. Cl. C40B 40/02

(52) U.S. Cl. 506/14

(57) ABSTRACT

A cell chip is provided which includes a first substrate having a micro channel extending from an upper surface thereof to a lower surface or a side surface thereof, and a first bio matrix arranged on the upper surface of the first substrate to cover the micro channel while containing cells. The cell chip supplies fluid to cells contained in the bio matrix by means of perfusion and diffusion, thereby providing an environment similar to a biological environment.

### CROSS REFERENCE TO RELATED APPLICATION

This application claims the benefit of Korean Patent Application No. 10-2010-0048226, filed on May 24, 2010, entitled “Cell Chip”, which is hereby incorporated by reference in its entirety into this application.

### BACKGROUND OF THE INVENTION

1. Technical Field

The present invention relates, in general, to a cell chip.

2. Description of the Related Art

Array based cell chips have a structure in which a plurality of through holes is aligned in an array on a substrate, and cells, fixed into the through holes, are cultured, and are used to measure reactions on a variety of drugs. Array based cell chips align a plurality of cells on a single substrate, so that they can advantageously perform diverse experiments. However, such array based cell chips have had a problem of generating inaccurate experimental results because their environment does not coincide with some biological environment.

There exists another kind of cell chip that has a structure having a bio matrix in which cells are provided on a flat substrate. In such cell chips, cells are supplied with nutritive elements and drugs which are injected into the bio matrix and diffused into the cells.

The structure of such cell chips has advanced into a structure which includes two opposed substrates, wherein a bio matrix is formed in each of opposite surfaces of the substrates, and that bio matrix which is formed on the lower side substrate contains cells. The bio matrix formed on the upper side substrate contains nutritive elements and drugs and supplies the contained nutritive elements and drugs to the bio matrix on the lower side.

While the approximation of cell chips having bio matrixes to biological environments has improved, the method of transferring nutritive elements and drugs to cells has been limited to diffusion.

Because in an actual biological environment nutritive elements and drugs are supplied to cells by perfusion via veins and diffusion to within the vicinity of veins, conventional cell chips had a problem such as inaccurate experimental results being obtained because an environment was provided which was different from the biological environment.

Furthermore, the conventional cell chips also had a problem in that the evaluation of drug characteristics could not be conducted for a long period of time because nutritive elements and drugs could not be continuously supplied to cells.

### SUMMARY OF THE INVENTION

Accordingly, the present invention has been made keeping in mind the above problems occurring in the related art, and the present invention is intended to propose a cell chip in which fluid, supplied from a fluid supply such as a pipette performs perfusion, flowing the fluid through a bio matrix and micro channels, after which the fluid is supplied to cells by diffusion in the bio matrix, thereby providing an environment similar to a biological environment.

Further, the present invention is intended to provide a cell chip capable of evaluating drug characteristics for a long time by continuously supplying fluid to cells contained in a bio matrix.

In order to achieve the above objects, according to one aspect of the present invention, there is provided a cell chip including a first substrate having a micro channel extending from an upper surface thereof to a lower surface or a side surface thereof, and a first bio matrix arranged on the upper surface of the first substrate to cover the micro channel while containing cells.

In an exemplary embodiment, the first bio matrix may be composed of collagen or alginate.

In an exemplary embodiment, the cell chip may further include an adhesive layer between contact surfaces of the first substrate and the first bio matrix.

In an exemplary embodiment, the micro channel formed in the first substrate and the first bio matrix covering the micro channel may be arranged in a multi-array.

In an exemplary embodiment, the plurality of micro channels may join at a point of intersection formed in the first substrate and extend to a single exit formed in the side surface of the first substrate.

In an exemplary embodiment, the single exit may be connected to a negative pressure pump discharging fluid flowing through the plurality of micro channels.

In an exemplary embodiment, the cell chip may further include a second substrate located above and spaced apart from the first substrate which supplies fluid through a through hole from an upper surface thereof to a lower surface thereof, and a second bio matrix arranged on an undersurface of the second substrate to cover the through hole while coming into contact with the first bio matrix.

In an exemplary embodiment, the through hole may be configured such that an area of an outlet in the side of the lower surface is smaller than that of an inlet in the side of the upper surface.

In an exemplary embodiment, the second substrate may further include a protrusion formed on the inlet of the through hole in the side of the upper surface.

In an exemplary embodiment, the second bio matrix may be composed of collagen or alginate.

In an exemplary embodiment, the second bio matrix may have a hemispheric shape.

In an exemplary embodiment, the cell chip may further include an adhesive layer between contact surfaces of the second substrate and the second bio matrix.

In an exemplary embodiment, the micro channel may be provided in a multiplicity of multi-arrays, and the second bio matrix and the through holes may have the same arrangement as those of the first bio matrix.

In an exemplary embodiment, the plurality of micro channels connected with the first bio matrix may join at a point of intersection formed in the first substrate and extend to a single exit formed in the side surface of the first substrate.

In an exemplary embodiment, the single exit may be connected with a negative pressure pump discharging fluid flowing through the plurality of micro channels.

According to the construction of the exemplary embodiments, since nutritive elements and drugs are supplied by perfusion and diffusion to cells contained in the bio matrix, cells can be cultivated in an environment similar to a biological environment.

Further, since two substrates, opposite surfaces of which are provided with bio matrixes, and nutritive elements and drugs are continuously supplied to cells contained in the bio matrix via the through holes formed in the upper substrate, it is possible to perform a long-term evaluation for drug characteristics.

Furthermore, since unit cell chips are provided in arrays on the single substrate, different kinds of nutritive elements and drugs can be supplied to the unit cell chips, so that cells cultivated under diverse environments can be observed.

### BRIEF DESCRIPTION OF THE DRAWINGS

The above and other objects, features and advantages of the present invention will be more clearly understood from the following detailed description when taken in conjunction with the accompanying drawings, in which:

FIG. 1 is a cross-sectional view schematically illustrating a cell chip according to a first embodiment;

FIG. 2 is a cross-sectional view illustrating a modified example of the cell chip shown in FIG. 1;

FIG. 3 is a perspective view schematically illustrating a cell chip having a plurality of unit cell chips provided in array form;

FIG. 4 is a plan sectional view illustrating a substrate provided in the cell chip of FIG. 3; FIG. 5 is a cross-sectional view schematically illustrating a cell chip according to a second embodiment;

FIGS. 6 to 8 are cross-sectional views illustrating modified examples of the cell chip shown in FIG. 5;

FIG. 9 is an exploded perspective view schematically illustrating a cell chip having the plurality of unit cell chips of FIG. 5 provided in array form; and

FIG. 10 is a side view illustrating the cell chip of FIG. 9.

### DETAILED DESCRIPTION OF THE INVENTION

Reference will now be made in greater detail to a preferred embodiment of the invention, an example of which is illustrated in the accompanying drawings. Wherever possible, the same reference numerals will be used throughout the drawings and the description to refer to parts that are the same or similar. In describing the present invention, if it is determined that the detailed description on the related known technology would make the gist of the present invention unnecessarily ambiguous, the detailed description will be omitted.

Prior to offering the description, it is noted that terms or words expressed in the specification and claims should not be limited to or construed by their conventional or dictionary meanings, but should be understood as meanings and concepts conforming with the technical spirits of the present invention because the inventor can properly define the concepts of terms or words used in order to clarify his/her invention in the best manner.

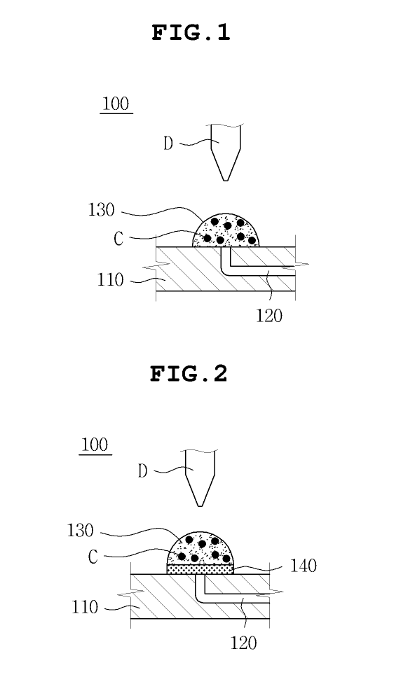

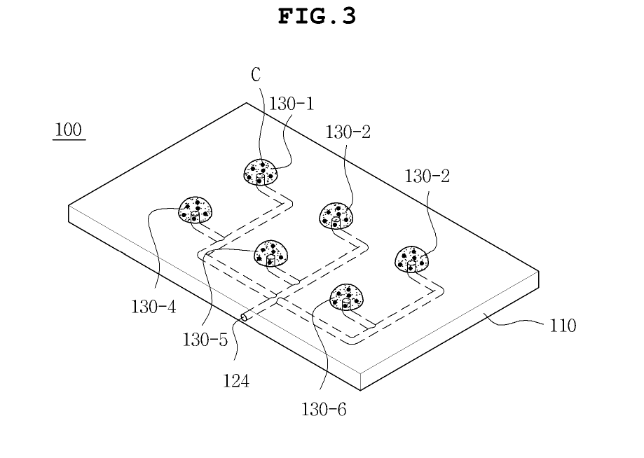

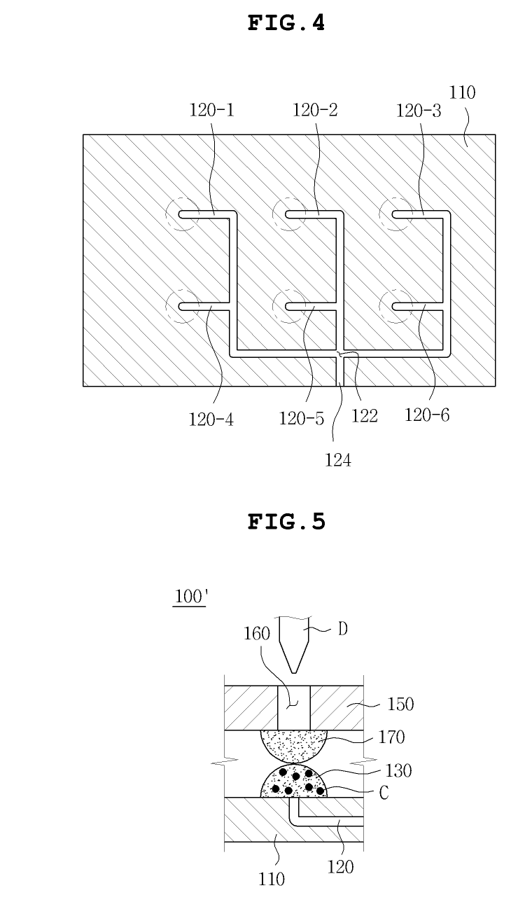

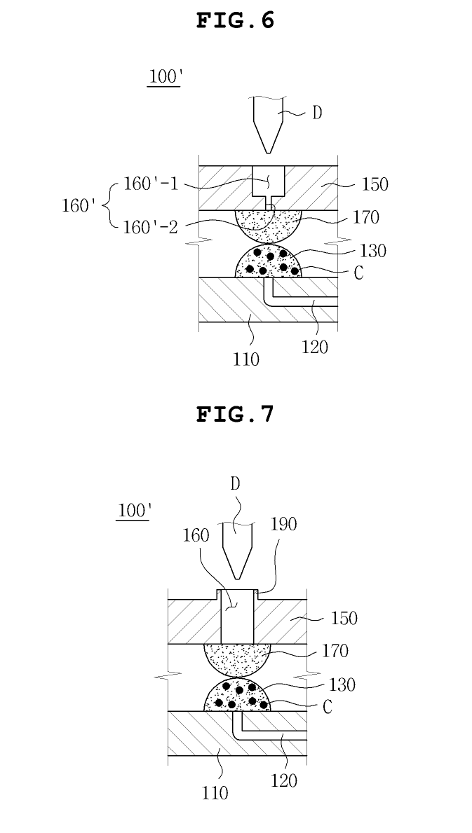

FIG. 1 is a cross-sectional view schematically illustrating a cell chip according to a first embodiment, FIG. 2 is a cross-sectional view illustrating a modified example of the cell chip shown in FIG. 1, FIG. 3 is a perspective view schematically illustrating a cell chip having a plurality of unit cell chips provided in array form, and FIG. 4 is a plan sectional view illustrating a substrate provided in the cell chip of FIG. 3. The cell chip of the first embodiment will now be described with reference to the drawings.

As illustrated in FIG. 1, the cell chip 100 contains a first substrate 110 having a micro channel 120, and a first bio matrix 130 arranged on the upper surface of the first substrate 110 to cover the micro channel 120 while containing cells C therein.

Examining fluid flowing in the cell chip 100 according to the embodiment, the fluid provided in a fluid dispenser D flows through the first bio matrix 130 and the micro channel 120 thereby to perform perfusion, and at the same time, is supplied to cells C by diffusion in the first bio matrix 130. Thus, the cell chip 100 creates an environment very similar to a biological environment because fluid can be supplied to cells by means of both perfusion and diffusion. Here, fluid being supplied from the fluid dispenser D may be nutritive elements that are used in cultivating cells, and diverse kinds of drugs, which may be known and changed to suit the purposes of the cell chips.

The first substrate 110 may be composed of glass, plastic or the like. The first substrate 110 may be of any shapes and thicknesses.

The micro channel 120 extends from an upper surface towards a lower surface or side surface of the first substrate 110, thereby serving to discharge the fluid supplied to the first bio matrix 130 outside. Here, if the micro channel 120 extends from the upper surface towards the side surface, it has a bent shape that is bent one or more times inside the first substrate 110.

The first bio matrix 130 which is formed on the upper surface of the first substrate 110 to cover the micro channel 120 may be bonded onto the first substrate 110 by curing the first bio matrix, or otherwise as illustrated in FIG. 2, may be attached to the first substrate by means of an adhesive. An adhesive layer 140 may be a PLL-barium chloride mixture and increases the binding force between the first substrate 110 and the first bio matrix 130.

The first bio matrix 130 stores a certain amount of fluid supplied from the fluid dispenser D, and supplies the fluid to the contained cells C. The bio matrix 130 may be composed of sol-gel, inorganic materials, organic polymers, or organic-inorganic composite materials. Particularly, the first bio matrix 130 may be collagen or alginate, preferably, having a porous structure through which fluid is diffused.

The cell chip 100 of the embodiment, as illustrated in FIGS. 3 and 4, includes an array structure in which a plurality of micro channels 120, formed in the first substrate 110, and a plurality of the first bio matrixes 130 (130-1 to 130-6) for covering the micro channels 120 are provided in arrays.

The cell chip 100 may be used to both simultaneously cultivate identical cells while supplying different kinds of fluids to the cells, thereby observing changes in how the same cell reacts with different fluids, and to simultaneously cultivate different kinds of cells while supplying identical fluid to the cells, thereby observing changes in how different cells react with the same fluid. Meanwhile, although the plurality of first bio matrixes 130 is provided in a 2×6 arrangement in FIG. 3, such an arrangement is an exemplary one.

Here, as illustrated in FIG. 4, it is preferred that the plurality of micro channels 120 (120-1 to 120-6), which is formed in the first substrate 110, join at a point of intersection 122 in the first substrate 110 and extends to a single exit 124 formed in the lower surface or side surface of the first substrate 110. While the micro channels may be formed to extend from the upper surface towards the lower surface of the first substrate 110, in this case, it is difficult to treat the fluid discharged. When the single exit 124 is formed in the first substrate 110 to solve this problem, the first bio matrixes 130 provided in an array are supplied with identical or different kinds of fluids, supply them to the respective cells, and extra fluid is discharged through the same exit, so that fluid can be easily treated without contaminating the substrate.

Further, as illustrated in FIG. 4, before the plurality of micro channels 120 joins at the point of intersection 122 in the first substrate 110, the neighboring micro channels 120 first join at different points in the first substrate, and then join at that point of intersection 122.

A negative pressure pump (not shown) may be connected to the single exit 124 in order to allow the fluid flowing through the micro channels 120 to be discharged. The negative pressure pump can regulate fluid flow discharged through the micro channels 120, thereby controlling the intensity of perfusion performed through the micro channels 120. The intensity of perfusion of a biological environment may differ according to the region of the living body. The negative pressure pump regulates the intensity of the perfusion created in the cell chip 100, thereby having the advantage of changing the environment into one very similar to that of a living body.

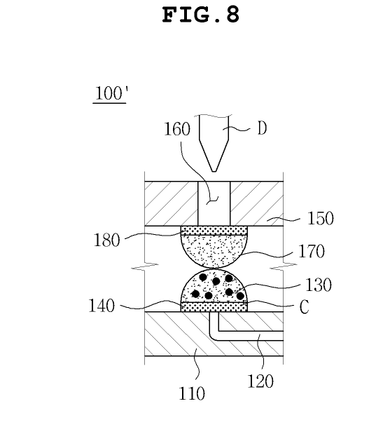

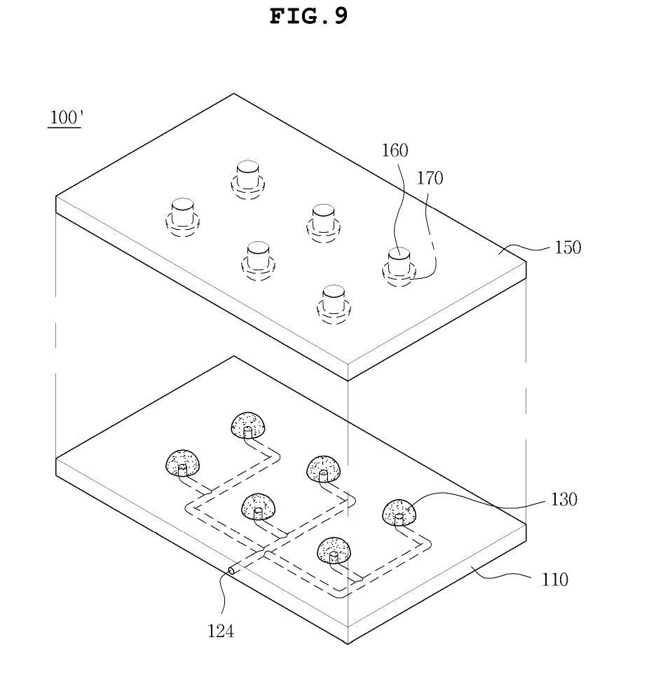

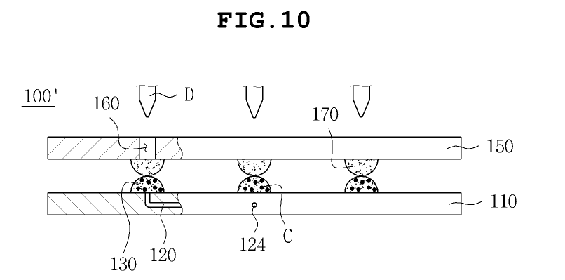

FIG. 5 is a cross-sectional view schematically illustrating a cell chip according to a second embodiment, FIGS. 6 to 8 are cross-sectional views illustrating modified examples of the cell chip shown in FIG. 5, FIG. 9 is an exploded perspective view schematically illustrating a cell chip having the plurality of unit cell chips of FIG. 5 provided in array form, and FIG. 10 is a side view illustrating the cell chip of FIG. 9. The cell chip of the second embodiment will now be described with reference to the above figures. However, the same construction as those described in FIGS. 1 to 4 will not be described in detail.

The cell chip 100′ of the embodiment further includes a second substrate 150, which is positioned above and separated from the first substrate 110 of the cell chip of FIG. 1, and which has a through hole 160 extending from an upper surface to a lower surface through which fluid flows, and a second bio matrix 170 which is arranged on an undersurface of the second substrate 150 so as to cover the through hole 160 while coming into contact with the first bio matrix 130. The cell chip 100′ of the embodiment can continuously supply nutritive elements and drugs to cells contained in the bio matrix via through holes formed in the upper substrate, thereby possibly performing long-term evaluation of drug characteristics.

Examining fluid flow in the cell chip 100′ of the embodiment, fluid supplied from the fluid dispenser D is discharged out of the micro channel 120 through the through hole 160 of the second substrate 150, the second bio matrix 170, and the first bio matrix 130, thereby performing perfusion. Then, the fluid flowing through the first bio matrix 130 is supplied to the cells C by means of diffusion in the first bio matrix 130. Thus, the cell chip 100′ of the embodiment can supply fluid to cells C by both perfusion and diffusion, thereby providing an environment very similar to the biological environment.

The second substrate 150 may be composed of glass, plastic or the like and be of any shape. Although not shown in FIG. 5, the first substrate 110 and the second substrate 150 may be separated from each other by a spacer. It is preferred that the spacer be arranged on an edge region of the substrate and that the thickness of the spacer be smaller than that of the first and second bio matrixes which are oppositely provided on the respective first and second substrates 110 and 150, such that the first and second bio matrixes are brought into contact with each other.

The through hole 160 extends from the upper surface towards the lower surface of the second substrate 150. The through hole 160 serves to supply fluid from the upper portion above the second substrate 150 towards the second bio matrix 170 formed on the undersurface of the second substrate 150.

It is also preferred that a through hole 160′ have different sectional areas in inlet and outlet portions in the side of the upper and lower surfaces of the second substrate, such that the inlet portion area is larger than the outlet portion area. Such a through hole 160′ serves both to supply fluid to the second bio matrix 170 and store a certain amount of fluid in the through hole 160′. As illustrated in FIG. 6, if the through hole 160′ comprises a large-area hole 160′-1 and a small-area hole 160′-2, the large-area hole 160′-1 serves to store fluid therein and the small-area hole 160′-2 serves to supply fluid to the second bio matrix 170.

Further, as illustrated in FIG. 7, a cell chip 100′ further includes a protrusion 190 which protrudes from the through hole 160 formed in the upper surface of the second substrate 150. The protrusion 190 stores fluid together with the through hole 160, and when the fluid is supplied to the through hole 160, also serves to prevent the fluid from running over the through hole 160, thereby excluding the occurrence of contamination of the second substrate 150.

The second bio matrix 170 is arranged on the undersurface of the second substrate 150 such that it covers the through hole 160. The second bio matrix 170 may be bonded onto the second substrate by curing the second bio matrix, or otherwise as illustrated in FIG. 8, may be attached to the second substrate by means of an adhesive. The adhesive layer 180 may be PLL-barium chloride mixture.

Similar to the first bio matrix 130, the second bio matrix 170 may be composed of sol-gel, inorganic materials, organic polymers, or organic-inorganic composite materials. The second bio matrix 170 may be collagen or alginate, preferably.

The second bio matrix 170 preferably has a hemispheric shape. Fluid supplied to the upper bio matrix 170 flows down towards the lower portion of the bio matrix by gravity, so that the fluid is collected on the lower portion of the first bio matrix 130, thereby facilitating fluid flow by means of diffusion and gravity.

The cell chip 100′ of the embodiment is configured such that as illustrated in FIGS. 9 and 10, the first bio matrix 130 is provided in multiplicity having a multi-array structure, and the second bio matrix 170 and the through hole 160 have the same arrangement as the first bio matrix 130.

The cell chip 100′ shown in FIGS. 9 and 10 is configured so that the unit cell chips 100′ of FIG. 5 are provided in array form on a single substrate. The cell chip 100′ may be used to both simultaneously cultivate identical cells while supplying different kinds of fluids to the cells, thereby observing how the reactions of the same cells change in different fluids, and to simultaneously cultivate different kinds of cells while supplying identical fluid to the cells, thereby observing changes in the reactions of different cells upon interacting with the same fluid.

Here, the micro channel 120 connected to the first bio matrix 130 may join at a point of intersection 122 in the first substrate 110 and extend to a single exit 124 formed in the lower surface or side surface of the first substrate 110.

Further, a negative pressure pump (not shown) may be connected to the single exit 124 in order to allow the fluid flowing through the micro channels 120 to be discharged. The negative pressure pump can regulate fluid flow discharged through the micro channels 120, thereby controlling the intensity of perfusion formed through the micro channels 120.

Although preferred embodiments of the present invention have been described for illustrative purposes, those skilled in the art will appreciate that the present invention is not limited thereto, but various modifications, additions and substitutions are possible, without departing from the scope and spirit of the invention as disclosed in the accompanying claims.

What is claimed is:

1. A cell chip comprising:
a first substrate having a micro channel extending from an upper surface thereof to a lower surface or a side surface thereof; and
a first bio matrix arranged on the upper surface of the first substrate to cover the micro channel while containing cells.

2. The cell chip according to claim 1, wherein the first bio matrix is composed of collagen or alginate.

3. The cell chip according to claim 1, further comprising: an adhesive layer between contact surfaces of the first substrate and the first bio matrix.

4. The cell chip according to claim 1, wherein the micro channel formed in the first substrate and the first bio matrix covering the micro channel are arranged in a multi-array.

5. The cell chip according to claim 1, wherein the plurality of micro channels join at a point of intersection formed in the first substrate and extends to a single exit formed in the side surface of the first substrate.

6. The cell chip according to claim 5, wherein the single exit is connected to a negative pressure pump discharging fluid flowing through the plurality of micro channels.

7. The cell chip according to claim 1, further comprising:
a second substrate located above and spaced apart from the first substrate, and having a through hole which supplies fluid from an upper surface thereof to a lower surface thereof; and
a second bio matrix arranged on an undersurface of the second substrate to cover the through hole while coming into contact with the first bio matrix.

8. The cell chip according to claim 7, wherein the through hole is configured such that an area of an outlet in the side of the lower surface is smaller than that of an inlet in the side of the upper surface.

9. The cell chip according to claim 7, wherein the second substrate further includes a protrusion formed on the inlet of the through hole in the side of the upper surface.

10. The cell chip according to claim 7, wherein the second bio matrix is composed of collagen or alginate.

11. The cell chip according to claim 7, wherein the second bio matrix has a hemispheric shape.

12. The cell chip according to claim 7, further comprising: an adhesive layer between contact surfaces of the second substrate and the second bio matrix.

13. The cell chip according to claim 7, wherein the micro channel is provided in a multiplicity of multi-arrays, and the second bio matrix and the through holes has the same arrangement as those of the first bio matrix.

14. The cell chip according to claim 13, wherein the plurality of micro channels connected with the first bio matrix join at a point of intersection formed in the first substrate and extends to a single exit formed in the side surface of the first substrate.

15. The cell chip according to claim 14, wherein the single exit is connected with a negative pressure pump discharging fluid flowing through the plurality of micro channels.
